(19) United States
(12) Patent Application Publication
(10) Pub. No.: US 2019/0057297 A1
(43) Pub. Date: Feb. 21, 2019

(54) LEVERAGING KNOWLEDGE BASE OF GROUPS IN MINING ORGANIZATIONAL DATA

(71) Applicant: MICROSOFT TECHNOLOGY LICENSING, LLC, Redmond, WA (US)

(72) Inventors: Haroon D. BARRI, Redmond, WA (US); Srikrishna GALI, Bellevue, WA (US); Kiran P. KAJA, Sammamish, WA (US)

(73) Assignee: MICROSOFT TECHNOLOGY LICENSING, LLC, Redmond, WA (US)

(21) Appl. No.: 15/679,996

(22) Filed: Aug. 17, 2017

(51) Int. Cl. G06N 3/00; G06F 17/30; G06N 5/00; G06N 5/04

(52) U.S. Cl. CPC G06N 3/006; G06F 17/30598; G06N 5/04; G06N 5/003; G06F 17/30958

(57) ABSTRACT

Approaches to leveraging knowledge base of groups in mining organizational data. A communication service initiates operation(s) to leverage knowledge base of groups upon detecting a question supplied by a requestor. Contextual information associated with the requestor is determined in relation to the question. Next, a knowledge graph is queried with the question and the contextual information. An answer associated with the question is identified within the knowledge graph. The answer includes a source. Furthermore, the answer and the source is provided to the requestor. Upon receiving to feedback associated with the answer from the requestor, the knowledge graph is modified based on the feedback.

### BACKGROUND

Information exchange have changed processes associated work and personal environments. Automation and improvements in processes have expanded scope of capabilities offered for personal and business data consumption. With the development of faster and smaller electronics, execution of mass processes at cloud systems have become feasible. Indeed, applications provided by data centers, data warehouses, data workstations have become common features in modern personal and work environments. Communication service(s) provide a wide variety of applications ranging from hosting, management, and/or presentation, among others associated with knowledge source(s).

Increasingly, cloud based resources are utilized for variety of services that include communication services, among others that facilitate hosting, management, and/or presentation, among other operations associated with assets such as knowledge source(s). However, there are currently substantial gaps in providing a knowledge base associated with a group. Personnel resources are unnecessarily consumed for processing, identifying, searching, and/or associating question(s) with answer(s) in a knowledge source. Lack of relevant management solutions to dynamically provide an automated historical knowledge source cause poor management of personnel resources and time when attempting to query, search, and locate an answer to a question associated with a group.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to leveraging knowledge base of groups in mining organizational data. A communication service, according to embodiments, may initiate operations to leverage knowledge base of groups upon detecting a question supplied by a requestor. Contextual information associated with the requestor may be determined in relation to the question. Next, a knowledge graph may be queried with the question and the contextual information. An answer associated with the question may be identified within the knowledge graph. The answer may include a source associated with the answer. Furthermore, the answer and the source may be provided to the requestor. Upon receiving a feedback associated with the answer from the requestor, the knowledge graph may be modified based on the feedback.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating examples of leveraging knowledge base of groups in mining organizational data, according to embodiments;

FIG. 2 is a display diagram illustrating example components of a communication service that provides leveraging knowledge base of groups in mining organizational data, according to embodiments;

FIG. 3 is a display diagram illustrating components of a scheme to provide leveraging knowledge base of groups in mining organizational data, according to embodiments;

FIG. 4 is a display diagram illustrating components of an additional scheme to provide leveraging knowledge base of groups in mining organizational data, according to embodiments;

FIG. 5 is a simplified networked environment, where a system according to embodiments may be implemented;

FIG. 6 is a block diagram of an example computing device, which may be used to provide leveraging knowledge base of groups in mining organizational data; and

FIG. 7 is a logic flow diagram illustrating a process for leveraging knowledge base of groups in mining organizational data, according to embodiments.

### DETAILED DESCRIPTION

As briefly described above, a communication service may leverage knowledge base of groups in mining organizational data. In an example scenario, the communication service may detect a question supplied by a requestor. The question may include a query seeking information on a subject. The question may also be inferred from a communication (received from the requestor) upon an analysis of the communication with a machine learning scheme. The machine learning scheme may include an entity extraction scheme, an intention detection scheme, and/or a natural language analysis scheme, among others. Next, a contextual information associated with the requestor may be determined in relation to the question. The contextual information may include an organizational position, a location, a presence information, a preference, and/or a relationship.

Furthermore, the communication service may query a knowledge graph with the question and the contextual information. The knowledge graph may include a data structure such as a tree based data structure that hosts and/or manages association(s) between question(s) and answer(s). An answer associated with the question may be identified within the knowledge graph. The answer may provide information associated with a subject of the question. The answer may include a source associated with the answer. The source may include a person and/or data who/that may provide additional information associated with the subject of the question.

Next, the answer and the source may be provided to the requestor. The answer and the source may be provided to a client device/application associated with the requestor and/or directly presented to the requestor through a user interface associated with the communication service. Furthermore, the answer may be suggested to the requestor as information associated with the subject of the question.

In addition, a feedback associated with the answer may be received from the requestor. The feedback may include a binary value such as a positive value or a negative value that affirms or refutes the answer as a match for the question. The knowledge graph may also be modified based on the feedback. A feedback that affirms the answer as a match for the question may be used to strengthen and/or solidify an association between the question and the answer within the knowledge graph. A feedback that refutes the answer as a match for the question may be used to remove an association between the question and the answer within the knowledge graph.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for leveraging knowledge base of groups in mining organizational data. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a bard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

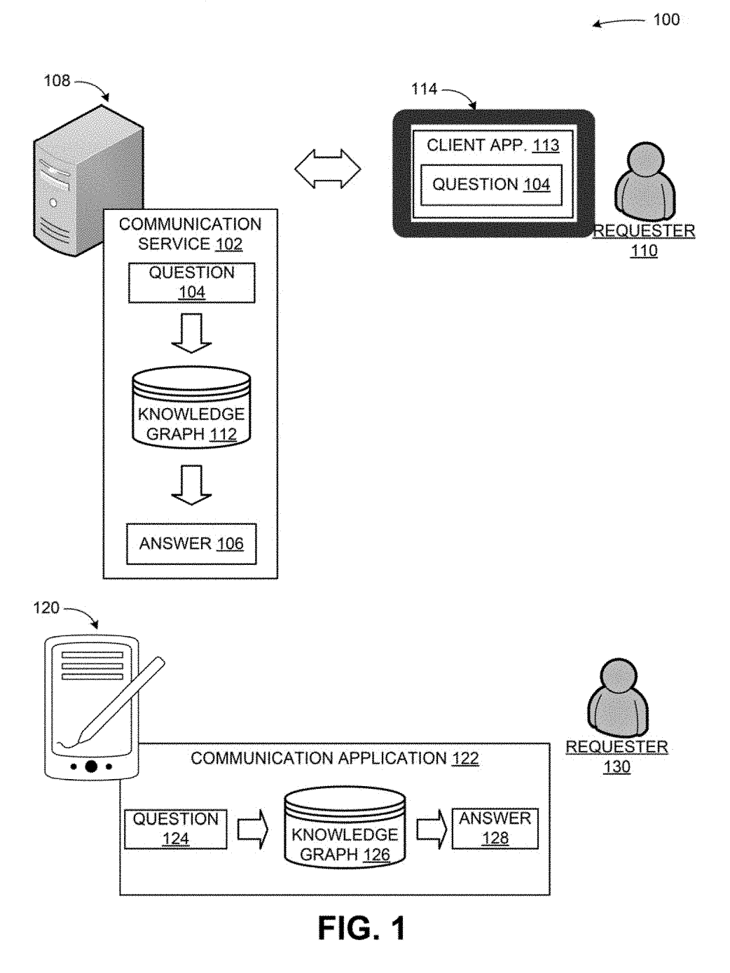

FIG. 1 is a conceptual diagram illustrating examples of leveraging knowledge base of groups in mining organizational data, according to embodiments.

In a diagram 100, a server 108 may execute (or provide) a communication service 102. The server 108 may include a physical server providing service(s), application(s), and/or an interface to client devices. A service (such as the communication service 102) may include an application performing operations in relation to a client application and/or a subscriber, among others. The server 108 may include and/or is part of a workstation, a data warehouse, a data center, and/or a cloud based distributed computing source, among others.

The server 108 may execute the communication service 102. The communication service 102 may detect a question 104 supplied by a requestor 110. In an example scenario, the requestor 110 may interact with a client application 113 (provided by a client device 114) to interact with the communication service 102 and provide the question 104 to the communication service 102. The question 104 may include a query seeking information on a subject.

The question 104 may be inferred from a communication (received from the requestor 110) upon an analysis of the communication with a machine learning scheme. An example of the communication may include an email. The machine learning scheme may include an entity extraction scheme, an intention detection scheme, and/or a natural language analysis scheme, among others. Next, a contextual information associated with the requestor 110 may be determined in relation to the question 104. The contextual information may include an organizational position, a location, a presence information, a preference, and/or a relationship.

Furthermore, the communication service 102 may query a knowledge graph 112 with the question 104 and the contextual information. An example of the knowledge graph 112 may include a data structure, such as a tree based data structure, that hosts and/or manages association(s) between question(s) and answer(s). In an example scenario, a tree based data structure may include a parent node and one or more children node(s) as a simple substructure. An example of the parent node may include the question 104. An example of the child node may include an answer 106. The tree based data structure may also designate a numerical (or other) value to an association (such as a link or an edge) between the parent node (the question 104) and the child node (the answer 106). The numerical value designated to the association may monetize the association between the question 104 and the answer 106.

The answer 106 associated with the question 104 may be identified within the knowledge graph 112. The answer 106 may provide information associated with a subject of the question 104. The answer 106 may include a source. The source may include a person and/or data who/that may provide additional information associated with the subject of the question 104.

Next, the answer 106 and the source may be provided to the requestor 110. The answer 106 and the source may be provided to the client application 113 (provided by the client device 114) associated with the requestor 110. Alternatively, the answer 106 and the source may be directly presented to the requestor 110 through a user interface associated with the communication service 102. Furthermore, the answer 106 may be suggested to the requestor 110 as information associated with the subject of the question 104.

In addition, a feedback associated with the answer 106 may be received from the requestor 110. The feedback may include a binary value such as a positive value or a negative value that affirms or refutes the answer 106 as a match for the question 104. The knowledge graph 112 may also be modified based on the feedback. A feedback that affirms the answer 106 as a match for the question 104 may be used to strengthen and/or solidify an association between the question 104 and the answer 106 within the knowledge graph 112. A feedback that refutes the answer 106 as a match for the question 104 may be used to remove an association between the question 104 and the answer 106 within the knowledge graph 112.

The server 108 may communicate with the client device 114 through a network. The network may provide wired or wireless communications between network nodes such as the client device 114 and/or the server 108, among others. Previous example(s) to leverage knowledge base of groups in mining organizational data are not provided in a limiting sense. Alternatively, the communication service 102 may search the knowledge graph 112 with the question 104, locate the answer 106 that matches the question 104 within the knowledge graph 112, and transmit the answer 106 to the requestor 110 as a desktop application, a workstation application, and/or a server application, among others. The client application 113 may also include a client interface interacting with the communication service 102.

The requestor 110 may interact with the client application 113 with a keyboard based input, a mouse based input, a voice based input, a pen based input, and a gesture based input, among others. The gesture based input may include one or more touch based actions such as a touch action, a swipe action, and a combination of each, among others.

Alternatively, a communication application 122 (provided by a computing device 120) may leverage knowledge base of groups in mining organizational data. An example of the communication application 122 may include a communication bot, among others. The communication application 122 may include an automated interface module that provides functionality (such as a user interface) to enable (or allow) interaction(s) with a requestor 130. Upon receiving a question 124 (from the requestor 110), the communication application 122 may query a knowledge graph 126 with the question 124. The communication application 122 may locate an answer 128 that matches the question 124 within the knowledge graph 126. Next, the answer 128 may be provided to the requestor 130. A feedback associated with the answer 128 may also be received from the requestor 130. The knowledge graph 126 may be modified based on the feedback.

While the example system in FIG. 1 has been described with specific components including the server 108, the communication service 102, embodiments are not limited to these components or system configurations and can be implemented with other system configuration employing fewer or additional components.

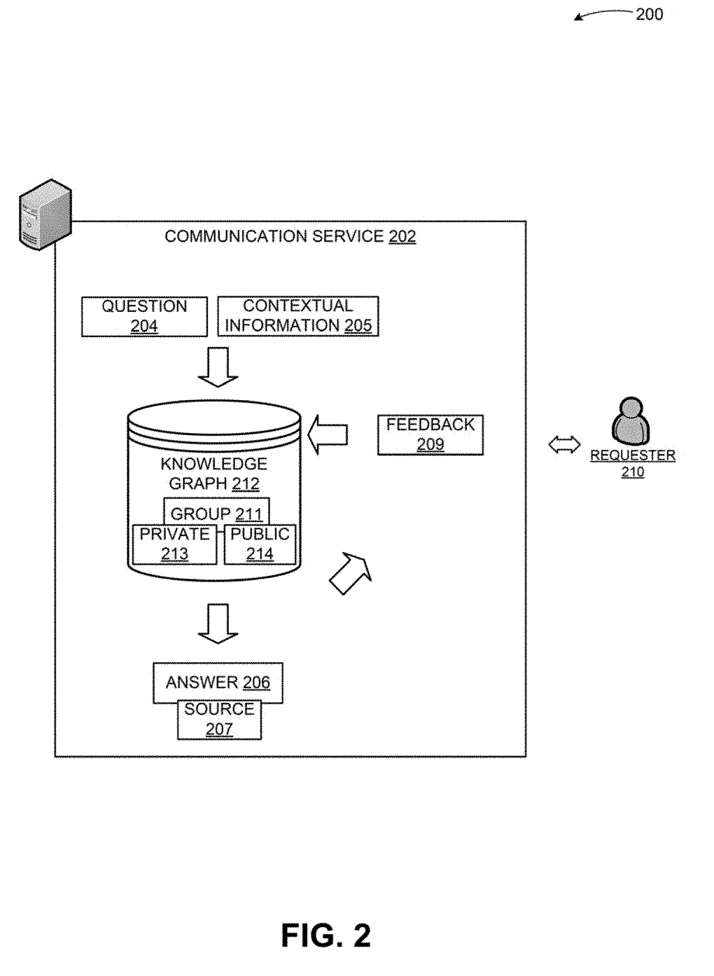

FIG. 2 is a display diagram illustrating example components of a communication service that provides leveraging knowledge base of groups in mining organizational data, according to embodiments.

As illustrated in diagram 200, a communication service 202 (provided by a server 208) may detect a question 204 provided by a requestor 210. The question 204 may include a query seeking information on a subject. The question 204 may be provided to the communication service 202 through a variety of communication modalities including email, text based message, an audio transmission, and/or a video transmission, among others.

The communication sell eke 202 may determine a contextual information 205 associated with the requester 210 in relation to the question 204. The contextual information 205 may include an organizational position, a location, a presence information, a preference, and/or a relationship. The contextual information 205 may be retrieved from local information associated with the requester 210 stored and/or hosted by the communication service 202 (or a local data provider). Alternatively, the contextual information 205 may be requested and/or retrieved from external provider(s) that host and/or manage information associated with the requestor 210.

The question 204 and the contextual information 205 may be used to query a knowledge graph 212. The knowledge graph 212 may store question(s) and associated answer(s) partitioned based on group(s). A knowledge base for a group 211 may be created by storing a question and one or more answer(s) that match the question as assets for the group 211. The group 211 may include one or more individual(s) who collaborate and/or communicate with each other. The requester 210 may be a member of the group 211. Furthermore, the group 211 may be private 213 which may restrict access to the knowledge base of question(s) and answer(a) associated with the group 211. Alternatively, the group 211 may be public 214 which may provide unrestricted access to the knowledge base of question(s) and answer(s) associated with the group 211.

In an example scenario, the communication service 202 may locate an answer 206 that matches the question within the knowledge graph 212. The knowledge graph 212 may be structured as a tree based data structure. For example, the knowledge graph 212 may be structured to include the group 211 as a top-level node. The question 204 may be a child node of the group 211. The answer 206 (and other answer(s)) may be a child node of the question 204. An association between the question 204 and the answer 206 may be monetized by assigning a value to the edge (or the link) between the two nodes. Strength of the association may be determined based on the designated value.

Alternatively, the knowledge graph 212 may be structured to have the question 204 as a top-level node. The group 211 may be designated as an attribute (such as an owner) of the question 204. The answer 206 may be designated as a child node of the question 204. In another example scenario, the answer 206 may be designated as a top-level node while designating the question 204 as a child node of the answer 206. The group 211 may be assigned as an attribute (such as an owner) of the answer 206.

The answer 206 may include a source 207 to provide additional information associated with a subject of the question 204. The source 207 may include a person (such as a stakeholder associated with the question 204) and/or data (such as an information source associated with the question 204). The answer 206 may be provided to the requestor 210 through a transmission, a presentation and/or as a suggested content for an auto generated communication, among others.

The requestor 210 may also provide a feedback 209 associated with the answer 206. The feedback 209 may affirm and/or refute the answer 206 as a match for the question 204. If the feedback 209 affirms the answer 206 then an association between the answer 206 and the question 204 may be strengthened (such as by ranking the answer 206 higher than other matching answer(s)). If the feedback 209 refutes the answer 206 as a match for the question 204 then an association between the question 204 and the answer 206 may be removed.

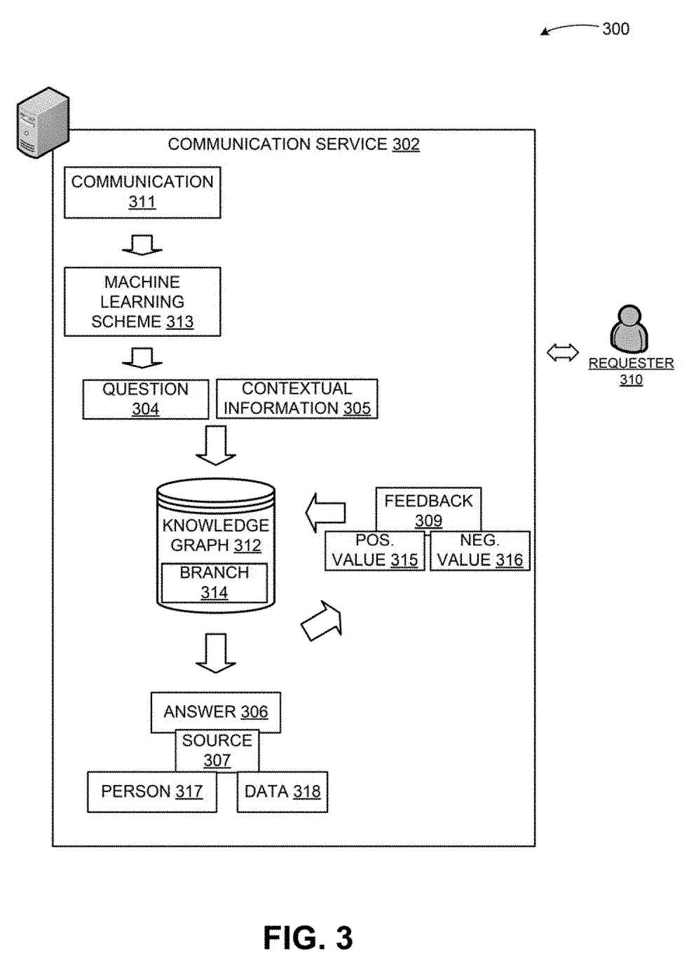

FIG. 3 is a display diagram illustrating components of a scheme to provide leveraging knowledge base of groups in mining organizational data, according to embodiments.

As shown in a diagram 300, a communication service 302 may receive a communication 311 from a requester 310. The communication 311 may be analyzed with a machine learning scheme 313 to detect a question 304 asked by the requester 310. For example, a title, a subject and/or a body of the communication 311 may be identified and analyzed to detect the question 304. The machine learning scheme 313 may include an entity extraction scheme, an intention detection scheme, and/or a natural language analysis scheme, among others. The entity extraction scheme may seek to locate and classify entities in a content (such as the communication 311). Intention detection scheme may identify concepts within a content (such as the communication 311) to determine an intention of an author of the content. The natural language analysis scheme may identify concept(s) and entity(s) within a content (such as the communication 311) to identify relationships) and other structure(s) between the concept(s) and the entity(s).

The communication service 302 may query a knowledge graph 312 with the question 304 and a contextual information 305 associated with the requester 310. The contextual information 305 may be used to focus the search to a branch 314 that is classified with a label similar to and/or associated with the contextual information 305. For example, the branch 314 may include a knowledge base of question(s) and associated answer(s) for a group. The branch may be annotated with a classification that is similar to and/or equal to the contextual information 305. As such, a query of the knowledge graph 312 with the contextual information 305 may lead to a search of the branch 314 (exclusively).

Next, the communication service 302 may locate an answer 306 that matches the question 304. The answer 306 may be matched to the question $04 by locating a parent node associated with the question 304 and selecting a child node as the answer 306. Furthermore, the answer 306 may be provided to the requester 310. If additional answer(s) are available as children node in association with the question 304 then the additional answer(s) may be provided to the requestor along with the answer 306. The answer 306 and the additional answer(s) may be ranked based on value(s) designated to the association(s) between the answer 306, the additional answer(s) and the question 304.

The answer 306 may be provided with a source 307. The source 307 may include a person 317 and/or data 318 who/that may provide additional information associated with the subject of the question 304. The source 307 may include a contact information associated with the person 317 and/or a link to the data 318.

A feedback 309 associated with the answer 306 may also be received from the requestor 310. The feedback 309 may affirm and/or refute an association between the question 304 and the answer 306. In an example scenario, a positive value 315 detected in the feedback 309 may be used to affirm (and/or confirm) the association between the question 304 and the answer 306. Alternatively, if a negative value 316 is detected in the feedback 309 then the association between the question 304 and the answer 306 may be removed from the knowledge graph 312.

A reply communication may also be automatically generated (in response to the communication 311). Attributes of the reply communication may be identified from a content of the question 304 and/or the answer 306 such as a title, a subject, a sender (such as the requestor 310), and/or a recipient, among others. The answer 306 may be inserted into a body of the reply communication.

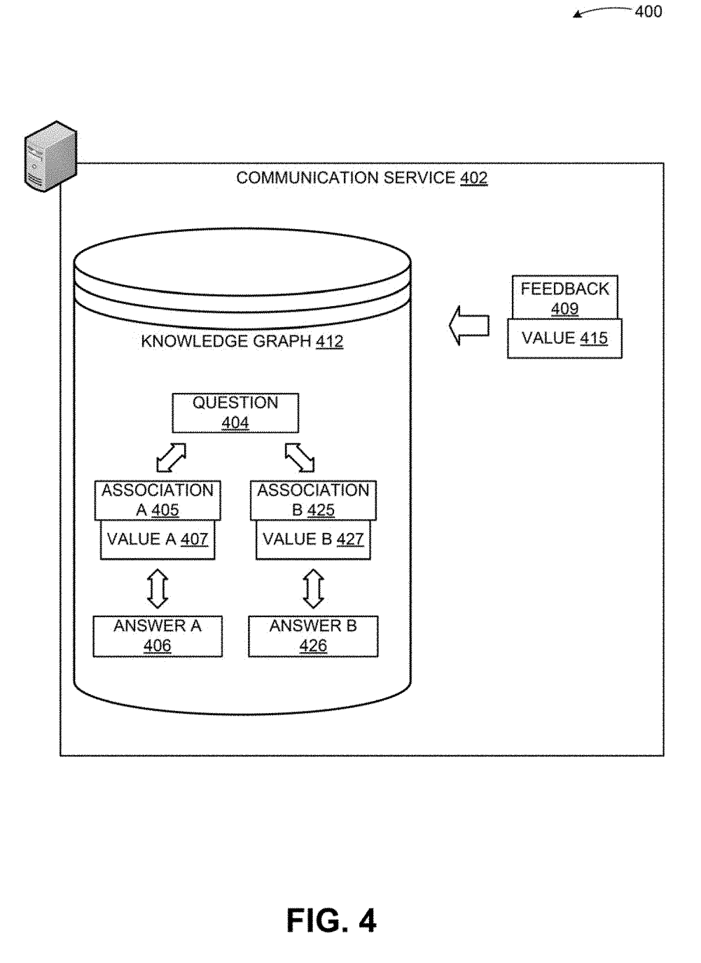

FIG. 4 is a display diagram illustrating components of an additional scheme to provide leveraging knowledge base of groups in mining organizational data, according to embodiments.

As shown in a diagram 400, a communication service 402 may receive a feedback 409 associated with an answer A 406. The feedback 409 may include a value 415 which may include a numerical value within a range. The value 415 may reflect a confidence requestor designates to an association A 405 between a question 404 and the answer A 406. For example, if the value 415 may include a high value within the range than the association A 405 may be affirmed. In such a scenario, the communication service 402 may increase a value A 407 designated to the association A 405 between the question 404 and the answer A 406. Alternatively, if the value 415 may include a low value within the range than the association A 405 may be refuted. In such a scenario, the communication service 402 may decrease the value A 407 designated to the association A 405 between the question 404 and the answer A 406. The communication service 402 may remove the association A 405 if the value A 407 falls below a designated threshold.

Furthermore, a modification of the knowledge graph 412 based on the feedback 409 may cause a value A 407 to be designated higher than a value B 427. The value B 427 may be designated to an association B 425 between the question 404 and an answer B 426. In such a scenario, the answer A 406 may be ranked higher than the answer B 426 when providing the answers to the requester.

As discussed above, the communication service may be employed to perform operations to provide leveraging knowledge base of groups in mining organizational data. An increased performance and efficiency improvement with the communication service 102 may occur as a result of automatically querying, locating, and providing an answer to a detected question. Additionally, automated query of a knowledge graph with a question and a contextual information for providing an answer based operation(s) and process(es) executed by the communication service 102, may reduce processor load, increase processing speed, conserve memory, and reduce network bandwidth usage.

Embodiments, as described herein, address a need that arises from a lack of efficiency in determining and providing answers in an organizational environment. The actions/operations described herein are not a mere use of a computer, but address results that are a direct consequence of software used as a service offered to large numbers of users and applications.

The example scenarios and schemas in FIG. 1 through 4 are shown with specific components, data types, and configurations. Embodiments are not limited to systems according to these example configurations. Leveraging knowledge base or groups in mining organizational data may be implemented in configurations employing fewer or additional components in applications and user interfaces. Furthermore, the example schema and components shown in FIG. 1 through 4 and their subcomponents may be implemented in a similar manner with other values using the principles described herein.

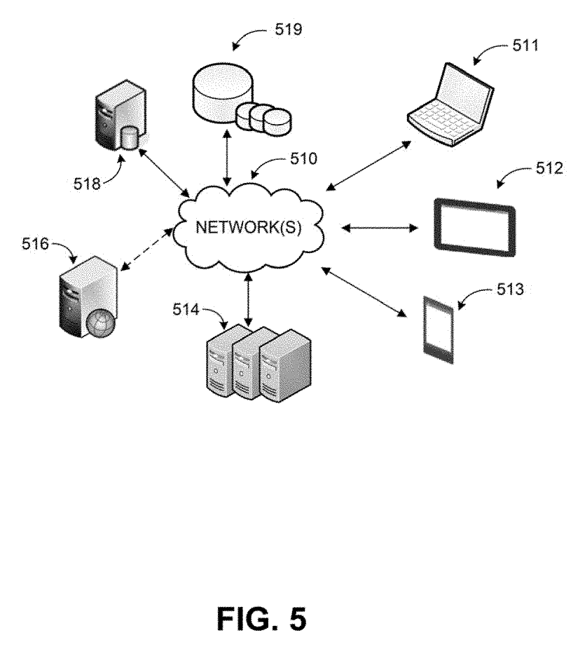

FIG. 5 is an example networked environment, where embodiments may be implemented. A communication service configured to leverage knowledge base of groups in mining organizational data may be implemented via software executed over one or more servers 514 such as a hosted service. The platform may communicate with client applications on individual computing devices such as a smart phone 513, a mobile computer 512, or desktop computer 511 (‘client devices’) through network(s) 510.

Client applications executed on any of the client devices 511-513 may facilitate communications via application(s) executed by servers 514, or on individual server 516. A communication service may detect a question supplied by a requestor. A contextual information associated with the requester may be determined in relation to the question. Next, a knowledge graph may be queried with the question and the contextual information. An answer associated with the question may be identified within the knowledge graph. The answer may include a source associated with the answer. Furthermore, the answer and the source may be provided to the requester. Upon receiving a feedback associated with the answer from the requestor, the knowledge graph may be modified based on the feedback. The communication service may store data associated with the knowledge graph in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to leverage knowledge base of groups in mining organizational data. Furthermore, the networked environments discussed in FIG. 5 are for illustration purposes only. Embodiments are not limited to the example applications, modules, or processes.

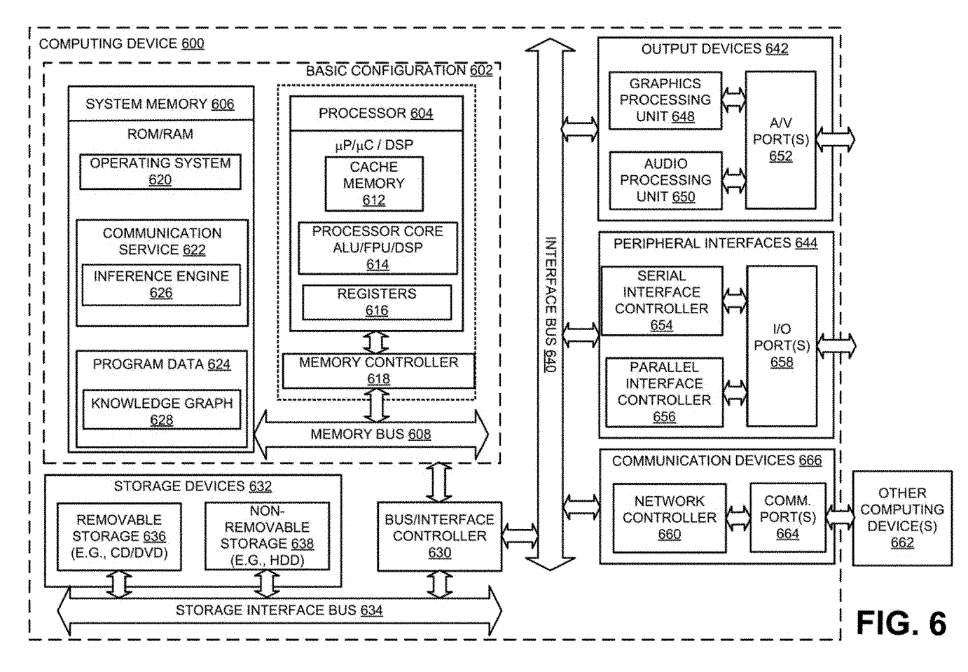

FIG. 6 is a block diagram of an example computing device, which may be used to provide leveraging knowledge base of groups in mining organizational data, according to embodiments.

For example, computing device 600 may be used as a server, desktop computer, portable computer, smart phone, special purpose computer, or similar device. In a basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating-point unit (FPU), a digital signal processing core (DSP Core), a graphics processing unit (GPU), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a communication service 622, and a program data 624. The communication service 622 may include components such as an inference engine 626. The inference engine 626 may execute the processes associated with the communication service 622. The inference engine 626 may detect a question supplied by a requestor. A contextual information associated with the requester may be determined in relation to the question. Next, a knowledge graph may be queried with the question and the contextual information. An answer associated with the question may be identified within the knowledge graph. The answer may include a source associated with the answer. Furthermore, the answer and the source may be provided to the requestor. Upon receiving a feedback associated with the answer from the requestor, the knowledge graph may be modified based on the feedback.

Input to and output out of the communication service 622 may be transmitted through a communication device 666 that may be communicatively coupled to the computing device 600. The communication device 666 may provide wired and/or wireless communication. The program data 624 may also include, among other data, knowledge graph 628, or the like, as described herein. The knowledge graph 628 may include a question linked to an answer through an association in a tree based data structure.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 666) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interlace controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example of the communication device(s) 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a specialized server, mainframe, or similar computer, which includes any of the above functions. The computing device 600 may also be implemented as a personal computer including both laptop computer and non-laptop computer configurations. Additionally, the computing device 600 may include specialized hardware such as an application-specific integrated circuit (ASIC), a field programmable gate array (FPGA), a programmable logic device (PLD), and/or a free form logic on an integrated circuit (IC), among others.

Example embodiments may also include methods to provide leveraging knowledge base of groups in mining organizational data. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

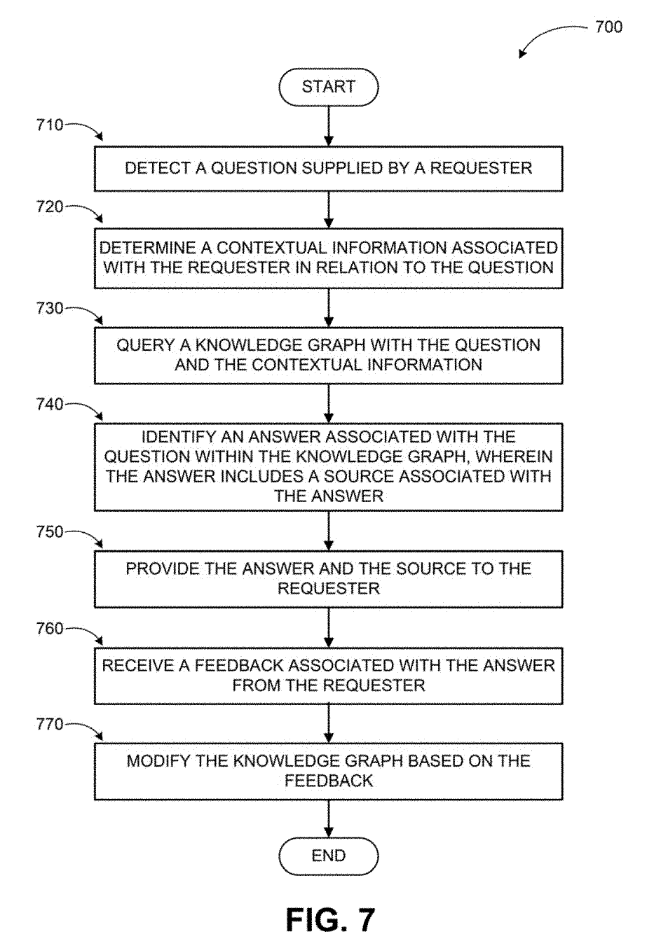

FIG. 7 is a logic flow diagram illustrating a process for leveraging knowledge base of groups in mining organizational data, according to embodiments. Process 700 may be implemented on a computing device, such as the computing device 600 or another system.

Process 700 begins with operation 710, where a communication service may detect a question supplied by a requestor. The question may include a query seeking information on a subject. At operation 720, a contextual information associated with the requestor may be determined in relation to the question. The contextual information may include a presence information, a location, and/or an organizational position, among others associated with the requestor. Next, at operation 730, a knowledge graph may be queried with the question and the contextual information. The knowledge graph may host and manage a parent node such as a question that is associated with a child node such as an answer.

At operation 740, an answer associated with the question may be identified within the knowledge graph. The answer may include a source associated with the answer. The source may include a person and/or data with additional information associated with a subject of the question. At operation 750, the answer and the source may be provided to the requestor. At operation 760, a feedback associated with the answer may be received from the requestor. The feedback may affirm or refute an association between the question and the answer. At operation 770, the knowledge graph may be modified based on the feedback.

The operations included in process 700 is for illustration purposes. Leveraging knowledge base of groups in mining organizational data may be implemented by similar processes with fewer or additional steps, as well as in different order of operations using the principles described herein. The operations described herein may be executed by one or more processors operated on one or more computing devices, one or more processor cores, specialized processing devices, and/or special purpose processors, among other examples.

According to some examples, a method to leverage knowledge base of groups in mining organizational data is described. The method includes detecting a question supplied by a requestor, determining contextual information associated with the requestor in relation to the question, querying a knowledge graph with the question and the contextual information, identifying an answer associated with the question within the knowledge graph, where the answer includes a source associated with the answer, providing the answer and the source to the requester, receiving a feedback associated with the answer from the requester, and modifying the knowledge graph based on the feedback.

According other examples, detecting the question supplied by the requester includes receiving a communication from the requester and inferring the question from the communication by processing the communication with one or more of an entity extraction scheme, an intent analysis scheme, or a natural language analysis scheme. The source includes a person, a group, or a data source. The method further includes providing the requester with contact information of the person, contact information of the group, or a link to the data source. The knowledge graph stores a historical knowledge associated with one or more of a private group and a public group.

According to further examples, the method further includes detecting the requester as a member of a first group, identifying a second group as a source for the answer within the knowledge graph, and granting the requester an access to the answer based on one or more of a classification associated with the second group or a permission granted by the second group. The second group is classified as a public group. The method further includes generating a response communication based on the answer and providing the response communication to the requestor. The method further includes determining one or more of a recipient, a subject, or a communication modality associated with the response communication based on the question and the contextual information associated with the requester, creating the response communication based on the one or more of the recipient, the subject, or the communication modality, and inserting the answer into a body section of the response communication.

According to other examples, determining the contextual information associated with the requester in relation the question includes identifying one or more of an organizational position, a location, a presence information, a preference, or a relationship associated with the requestor as the contextual information and designating the question with a classification based on the contextual information. The method further includes locating a branch of the knowledge graph associated with the classification and searching the branch of the knowledge graph to identify the answer associated with the question.

According to some examples, a server configured to leverage knowledge base of groups in mining organizational data is described. The server includes a communication device configured to facilitate communication between a communication service and one or more client devices, a memory configured to store instructions, and a processor coupled to the memory and the communication device. The processor executes the communication service in conjunction with the instructions stored in the memory. The communication service includes an inference engine. The inference engine is configured to receive a communication from a requestor, infer a question from the communication by processing the communication with a machine learning scheme, where the machine learning scheme includes one or more elan entity extraction scheme, an intent analysis scheme, or a natural language analysis scheme, determine contextual information associated with the requestor relation to the question, where the contextual information includes one or more of an organizational position, presence information, a preference, or a relationship associated with the requestor, identify a first answer associated with the question by querying a knowledge graph, transmit, through the communication device, the first answer to the requestor, receive, through the communication device, a feedback associated with the first answer from the requestor, and submit a modification to the knowledge graph based on the feedback.

According to other examples, the feedback associated with the first answer includes a positive value that designates the first answer as a match for the question or a negative value that designates the first answer as a mismatch for the question. The inference engine is further configured to determine the feedback to designate the first answer as a mismatch for the question and remove an association between the question and the first answer within the knowledge graph. The inference engine is further configured to determine the feedback to designate the first answer as a match for the question and affirm a first association between the question and the first answer within the knowledge graph. Affirming the first association between the question and the first answer includes one or more operations to rank the first association between the question and the first answer higher than a second association between the question and a second answer.

According to further examples the inference engine is further configured to identify a second answer associated with the question by querying the knowledge graph and provide, through the communication device, the second answer to the requester along with the first answer. The inference engine is further configured to identify a first value designated to a first association between the question and the first answer and a second value designated to a second association between the question and the second answer within the knowledge graph and transmit, through the communication device, the first answer and the second answer to the requestor as ranked based on the first value and the second value.

According to some examples a computing device to leverage knowledge base of groups in mining organizational data is described. The computing device includes a communication device configured to facilitate communication between a communication application and a client device, a memory configured to store instructions, and a processor coupled to the memory and the communication device. The processor executes the communication application in conjunction with the instructions stored in the memory. The communication application includes an automated interface module. The automated interface module is configured to receive, through the communication device, a communication from a requestor, infer a question from the communication by processing the communication with a machine learning scheme, determine contextual information associated with the requestor in relation to the question, identify an answer associated with the question by querying a knowledge graph, transmit, through the communication device, the answer to the requestor, receive, through the communication device, a feedback associated with the answer from the requestor, and modify the knowledge graph based on the feedback.

According to other examples, the automated interface module is further configured to detect a first value associated with the feedback and adjust a second value designated to an association between the question and the answer within the knowledge graph based on the first value.

According to some examples, a means for leveraging knowledge base of groups in mining organizational data is described. The means for leveraging knowledge base of groups in mining organizational data includes a means for detecting a question supplied by a requestor, a means for determining contextual information associated with the requestor relation to the question, a means for querying a knowledge graph with the question and the contextual information, a means for identifying an answer associated with the question within the knowledge graph, where the answer includes a source associated with the answer, a means for providing the answer and the source to the requestor, a means for receiving a feedback associated with the answer from the requestor, and a means for modifying the knowledge graph based on the feedback.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to leverage knowledge base of groups in mining organizational data, the method comprising;
detecting a question supplied by a requestor;
determining contextual information associated with the requestor in relation to the question;
querying knowledge graph with the question and the contextual information;
identifying an answer associated with the question within the knowledge graph, wherein the answer includes a source associated with the answer;
providing the answer and the source to the requestor;
receiving a feedback associated with the answer from the requestor; and
modifying the knowledge graph based on the feedback.

2. The method of claim 1, wherein detecting the question supplied by the requestor comprises:
receiving a communication from the requestor; and
inferring the question from the communication by processing the communication with one or more of an entity extraction scheme, an intent analysis scheme, or a natural language analysis scheme.

3. The method of claim 1, wherein the source includes a person, a group, or a data source.

4. The method of claim 3, further comprising:
providing the requestor with contact information of the person, contact information of the group, or a link to the data source.

5. The method of claim 1, wherein the knowledge graph stores a historical knowledge associated with one or more of a private group and a public group.

6. The method of claim 1, further comprising:
detecting the requestor as a member of a first group;
identifying a second group as a source for the answer within the knowledge graph; and
granting the requestor an access to the answer based on one or more of a classification associated with the second group or a permission granted by the second group.

7. The method of claim 6, wherein the second group is classified as a public group.

8. The method of claim 1, further comprising:
generating a response communication based on the answer; and
providing the response communication to the requestor.

9. The method of claim 8, further comprising:
determining one or more of a recipient, a subject, or a communication modality associated with the response communication based on the question and the contextual information associated with the requestor;
creating the response communication based on the one or more of the recipient, the subject, or the communication modality; and
inserting the answer into a body section of the response communication.

10. The method of claim 1, wherein determining the contextual information associated with the requestor in relation to the question comprises:
identifying one or more of an organizational position, a location, a presence information, a preference, or a relationship associated with the requestor as the contextual information; and
designating the question with a classification based on the contextual information.

11. The method of claim 10, further comprising:
locating a branch of the knowledge graph associated with the classification; and
searching the branch of the knowledge graph to identify the answer associated with the question.

12. A server configured to leverage knowledge base of groups in mining organizational data, the server comprising:
a communication device configured to facilitate communication between a communication service and one or more client devices;
a memory configured to store instructions; and
a processor coupled to the memory and the communication device, the processor executing the communication service in conjunction with the instructions stored in the memory, wherein the communication service includes:
an inference engine configured to:
receive a communication from a requestor;
infer a question from the communication by processing the communication with a machine learning scheme, wherein the machine learning scheme includes one or more of an entity extraction scheme, an intent analysis scheme, or a natural language analysis scheme;
determine contextual information associated with the requestor in relation to the question, wherein the contextual information includes one or more of an organizational position, presence information, a preference, or a relationship associated with the requestor;
identify a first answer associated with the question by querying a knowledge graph;
transmit, through the communication device, the first answer to the requestor;
receive, through the communication device, a feedback associated with the first answer from the requestor; and
submit a modification to the knowledge graph based on the feedback.

13. The server of claim 12, wherein tie feedback associated with the first answer includes one of:
a positive value that designates the first answer as a match for the question, and
a negative value that designates the first answer as a mismatch for the question.

14. The server of claim 12, wherein the inference engine is further configured to:
determine the feedback to designate the first answer as a mismatch for the question; and
remove an association between the question and the first answer within the knowledge graph.

15. The server of claim 12, wherein the inference engine is further configured to:
determine the feedback to designate the first answer as a match for the question; and
affirm a first association between the question and the first answer within the knowledge graph.

16. The server of claim 15, wherein affirming the first association between the question and the first answer includes one or more operation to:
rank the first association between the question and the first answer higher than a second association between the question and a second answer.

17. The server of claim 12, wherein the inference engine is further configured to:
identify a second answer associated with the question by querying the knowledge graph; and
provide, through the communication device, the second answer to the requestor along with the first answer.

18. The server of claim 17, wherein the inference engine is further configured to:
identify a first value designated to a first association between the question and the first answer and a second value designated to a second association between the question and the second answer within the knowledge graph; and
transmit, through the communication device, the first answer and the second answer to the requestor as ranked based on the first value and the second value.

19. A computing device to leverage knowledge base of groups in mining organizational data, the computing device includes:
a communication device configured to facilitate communication between a communication application and a client device;
a memory configured to store instructions; and
a processor coupled to the memory and the communication device, the processor executing the communication application in conjunction with the instructions stored in the memory, wherein the communication application includes:
an automated interface module configured to:
receive, through the communication device, a communication from a requestor;
infer a question from the communication by processing the communication with a machine learning scheme;
determine contextual information associated with the requestor in relation to the question;
identify an answer associated with the question by querying a knowledge graph;
transmit, through the communication device, the answer to the requestor;
receive, through the communication device, a feedback associated with the answer from the requestor; and
modify the knowledge graph based on the feedback.

20. The computing device of claim 19, wherein the automated interface module is further configured to:
detect a first value associated with the feedback; and
adjust a second value designated to an association between the question and the answer within the knowledge graph based on the first value.
